(19) United States
(12) Patent Application Publication
(10) Pub. No.: US 2026/0329682 A1
(43) Pub. Date: Oct. 22, 2026

(54) EVENT LOG ANALYSIS SYSTEM AND EVENT LOG ANALYSIS METHOD

(71) Applicant: PEGATRON CORPORATION, TAIPEI CITY (TW)

(72) Inventors: Heng-Hsuan Chang, Taipei City (TW); Jen-Hao Hsiao, Taipei City (TW); Ming-Chun Kuo, Taipei City (TW); Wei-Cheng Su, Taipei City (TW); Po-Wei Huang, Taipei City (TW); Nai-Chen Chang, Taipei City (TW)

(73) Assignee: PEGATRON CORPORATION, TAIPEI CITY (TW)

(21) Appl. No.: 19/559,693

(22) Filed: Mar. 6, 2026

(30) Foreign Application Priority Data
Apr. 22, 2025 (TW) 114115138

(51) Int. Cl. G06F 11/07; G06F 11/30

(52) U.S. Cl. CPC G06F 11/0769; G06F 11/3072

(57) ABSTRACT

The present disclosure provides an event log analysis system and an event log analysis method. The event log analysis method comprises: receiving multiple operating system events; screening out multiple identified events from the multiple operating system events based on multiple error information stored in a first database; determining whether the multiple identified events include at least one of a first hardware error event corresponding to a first hardware error type and a second hardware error event corresponding to a second hardware error type; in response to the first hardware error event, decoding the first hardware error event according to decoding information to obtain first hardware error information of the first hardware error event; in response to the second hardware error event, providing a download path for the second hardware error event; and generating an analysis report, wherein the analysis report includes the first hardware error information and the download path.

### CROSS-REFERENCE TO RELATED APPLICATION

This application claims the priority benefit of Taiwan application serial no. 114115138, filed on Apr. 22, 2025. The entirety of the above-mentioned patent application is hereby incorporated by reference herein and made a part of this specification.

### BACKGROUND

### Technical Field

The present disclosure relates to the field of computer system maintenance and fault diagnosis, and more particularly, to a system and a method for automatically analyzing event logs of a computer system, and is particularly suitable for analysis of event logs (Event Log) of an operating system.

### Description of Related Art

In computer system maintenance and fault diagnosis, system event logs are an important diagnostic tool, which record various events during system operation, including information such as system startup, shutdown, hardware errors, and driver problems. The Windows operating system has a built-in Event Viewer tool for system administrators and users to view and analyze the logs of these events.

A conventional method for analyzing Windows system event logs is as follows: opening the built-in Event Viewer of the Windows operating system, expanding the Windows Log, and manually filtering information of each System Event Log. If the time when an error has occurred or a specific event identifier (Event ID) is known, a filtering function may be used to further organize the information, and then manual interpretation of the Windows Event Logs is performed.

However, the conventional event log analysis method has many problems. First, system event logs usually contain a large amount of information (up to tens of thousands of entries), and reviewing them one by one manually is time-consuming and laborious. Second, manual interpretation is susceptible to the influence of subjective factors, which leads to errors or omissions in the analysis results, thereby reducing the accuracy of the diagnosis. In addition, some special types of logs require special decoding methods, and it is difficult for conventional tools to directly process these complex log formats, which are often in a raw binary format, making them human-unreadable and incompatible with generic log viewers.

### SUMMARY

The present disclosure provides an event log analysis system and an event log analysis method for solving the problem that it is difficult for conventional tools to directly process these complex log formats, which can automatically filter and analyze operating system event logs, and is particularly capable of identifying and decoding specific types of hardware error events, so as to improve the efficiency of analysis and the functionality of the computer diagnostic system itself.

One or more embodiments of the present disclosure provide an event log analysis system, comprising: a data receiving module, for receiving a plurality of operating system events; a first database, for storing a plurality of error information; a second database, for storing decoding information; and a processor, coupled to the data receiving module, the first database, and the second database, wherein the processor is configured to: screen out a plurality of identified events from the plurality of operating system events based on the plurality of error information; determine whether the plurality of identified events include at least one of a first hardware error event corresponding to a first hardware error type and a second hardware error event corresponding to a second hardware error type; in response to the first hardware error event, decode the first hardware error event according to the decoding information to obtain first hardware error information of the first hardware error event; in response to the second hardware error event, provide a download path corresponding to the second hardware error event; and generate an analysis report, wherein the analysis report includes the first hardware error information and the download path.

In one or more embodiments of the present disclosure, the first hardware error type is UEFI Windows Hardware Error Architecture (WHEA), and the second hardware error type is Intel Crash log WHEA.

In one or more embodiments of the present disclosure, the plurality of error information includes a plurality of known error codes, wherein screening out the plurality of identified events from the plurality of operating system events based on the plurality of error information comprises: filtering the plurality of operating system events based on a plurality of identifiers of the plurality of operating system events to obtain a plurality of filtered operating system events; determining whether a plurality of error codes of the plurality of filtered operating system events matches a plurality of known error codes to generate a matching result; and screening out the plurality of identified events based on the matching result.

In one or more embodiments of the present disclosure, the processor is further configured to group and label the plurality of identified events and set display colors of the plurality of identified events in the analysis report according to a plurality of problem types, wherein the plurality of problem types includes at least one of the following: a hardware problem type, including the first hardware error type and the second hardware error type; a software problem type; and a firmware problem type.

In one or more embodiments of the present disclosure, the processor is further configured to: arrange the plurality of identified events in a chronological order in the analysis report according to a plurality of timestamps of the plurality of identified events.

In one or more embodiments of the present disclosure, the processor is further configured to: determine the first hardware error event and the second hardware error event according to a first preset length and a second preset length, wherein a data length of the first hardware error event is greater than the first preset length and less than the second preset length, and a data length of the second hardware error event is greater than the second preset length.

In one or more embodiments of the present disclosure, the processor is further configured to: when the plurality of identified events comprises other events not belonging to either the first hardware error type or the second hardware error type, determine whether the other events have new error information that is not present in the first database; and in response to the new error information, add the new error information to the first database.

Based on the above, the event log analysis system and the event log analysis method provided by the present disclosure can effectively improve the efficiency of event log analysis. The system screens out identified events from a plurality of operating system events through the processor according to the error information of the first database, greatly reducing the display of event logs that need to be processed and shortening the analysis time. The processor further determines whether the identified events include the first hardware error event or the second hardware error event, and processes them by decoding (using the second database) or providing a download path to adapt to the diagnostic needs of different hardware errors. The finally generated analysis report integrates the first hardware error information and the download path. In addition, the present disclosure continuously optimizes the error identification capability through iterative updates, and can adapt to changing system environments and new error types.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure and are incorporated in and constitute a part of this specification. The drawings illustrate exemplary embodiments of the disclosure and, together with the description, serve to explain the principles of the disclosure.

FIG. 1 is a schematic block diagram of an event log analysis system according to an embodiment of the present disclosure.

FIG. 2 is a flowchart of an event log analysis method according to an embodiment of the present disclosure.

FIG. 3A is a schematic diagram of a file overview interface of an analysis report according to an embodiment of the present disclosure.

FIG. 3B is an example diagram of the file overview interface according to an embodiment of the present disclosure.

FIG. 4A is a schematic diagram of an event list interface of an analysis report according to an embodiment of the present disclosure.

FIG. 4B is a schematic diagram of a row in the event information area of FIG. 4A.

FIG. 5 is an example diagram of the event information area of FIG. 4A.

FIG. 6 is a flowchart of a log analysis method according to another embodiment of the present disclosure.

### DESCRIPTION OF THE EMBODIMENTS

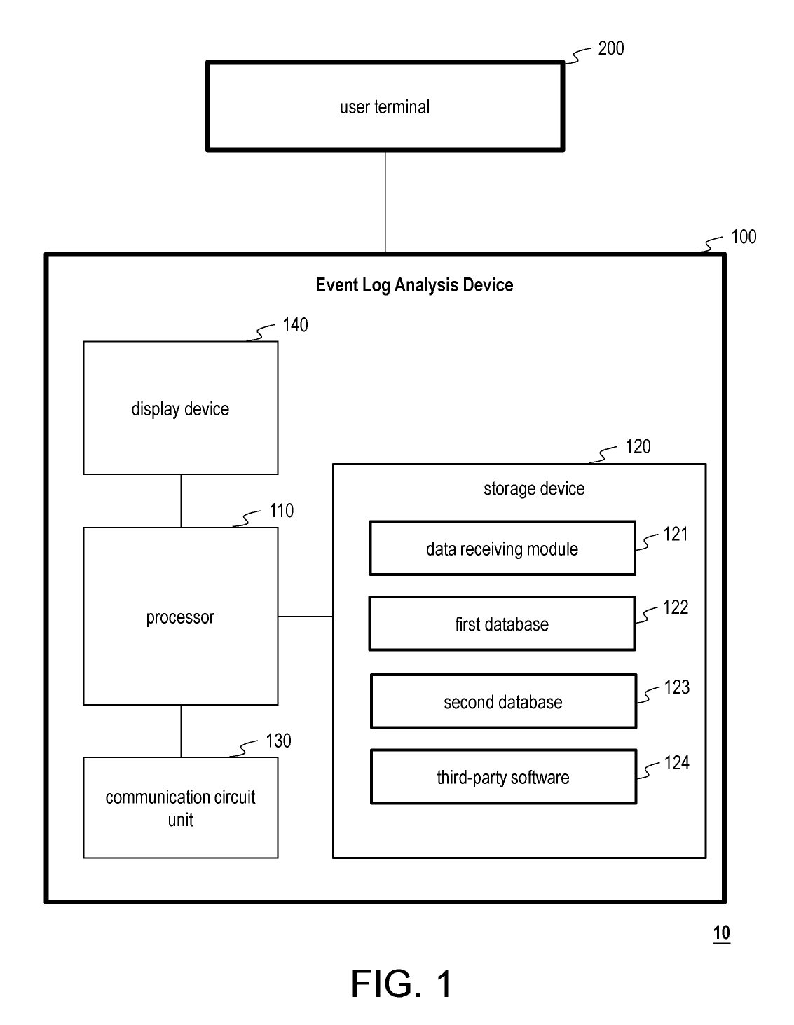

FIG. 1 is a schematic block diagram of an event log analysis system according to an embodiment of the present disclosure.

Referring to FIG. 1, in an embodiment, the event log analysis system 10 includes an event log analysis device 100 and a user terminal 200. The event log analysis device 100 includes a processor 110, a storage device 120, a communication circuit unit 130, and a display device 140. The storage device 120 further includes a data receiving module 121, a first database 122, a second database 123, and a third-party software 124. The event log analysis device 100 is communicatively connected to the user terminal 200.

In this embodiment, the event log analysis device 100 may be specifically implemented as an analysis device of a network server, a cloud computing platform, a workstation, or a data center, which is capable of processing event log files containing a large number of Windows operating system events and provides a Web interface for a user to upload the event log files. The user terminal 200 may be a laptop computer, a desktop computer, a tablet computer, a smartphone, or any electronic device with a web browsing function. A user may access the service interface provided by the event log analysis device 100 through a Web browser to upload event log files and receive analysis results, without installing dedicated client software. In an enterprise environment, the user terminal 200 is usually a work computer used by IT technical support personnel or system administrators for diagnosing and maintaining a system in which problems may occur.

In this embodiment, the processor 110 is coupled to the storage device 120, the communication circuit unit 130, and the display device 140 for executing instructions (e.g., program code modules) stored in the storage device 120 to conduct event log analysis. The processor 110 receives a plurality of operating system events from the data receiving module 121 and screens out a plurality of identified events based on a plurality of error information stored in the first database 122. The processor 110 also determines whether the identified events include at least one of a first hardware error event corresponding to a first hardware error type and a second hardware error event corresponding to a second hardware error type.

In an embodiment, the operating system events may be Windows events, which are contained in Windows event log files (.evtx), and a plurality of event log files may be compressed into a ZIP file. The first database 122 is for storing a plurality of error information, including a plurality of known error codes and corresponding error descriptions. The processor 110 may screen out identified events that conform with the error information from the operating system events. The first database 122 also stores classification information of different problem types, such as a hardware problem type, a software problem type, and a firmware problem type, so that the processor 110 can group and label the identified events.

In another embodiment, in response to the first hardware error event, the processor 110 decodes the first hardware error event according to the decoding information stored in the second database 123 to obtain the first hardware error information of the first hardware error event. The processor 110 also, in response to the second hardware error event, provides a download path corresponding to the second hardware error event. Finally, the processor 110 generates an analysis report which includes the first hardware error information and the download path, and displays the analysis report to a user through the display device 140.

In another embodiment, the first hardware error type is Unified Extensible Firmware Interface (hereinafter referred to as UEFI) Windows Hardware Error Architecture (hereinafter referred to as WHEA), and the second hardware error type is Intel Crash log WHEA. The second database 123 is for storing decoding information, particularly for decoding error events of the UEFI WHEA type. The decoding information includes correspondence relationships between error codes and hardware components, and parsing rules for error fragments, enabling the processor 110 to convert the log information of the aforementioned types of error events in binary into human-readable text content.

In another embodiment, the third-party software 124 is a third-party analysis tool such as Intel System Debugger, which is imported into the event log analysis device 100 for parsing error events of the Intel Crash log WHEA type. Since the decoding of the Intel Crash log requires a proprietary tool from Intel, the system integrates it into the event log analysis system, allowing a user to directly complete the uploading and analysis of the Intel Crash log within the system.

In another embodiment, the communication circuit unit 130 is for establishing and maintaining a communication connection between the event log analysis device 100 and the user terminal 200, such as a local area network connection or an internet connection. Through the communication circuit unit 130, a user can upload event log files via the user terminal 200 and receive analysis results. The communication circuit unit 130 may include a wired communication interface (such as an Ethernet card, an optical fiber interface) and a wireless communication interface (such as a Wi-Fi module, a Bluetooth module) and support a plurality of communication protocols and standards.

In another embodiment, the display device 140 is for displaying the analysis report generated by the processor 110. The display device 140 supports visual presentation of the report to mark different types of event problems in different colors, and the processor 110 arranges the events in chronological order, making it convenient for a user to analyze the evolution process of a problem on the display device 140. The display device 140 may be a liquid crystal display (LCD), a light-emitting diode (LED) display, an organic light-emitting diode (OLED) display, or another device suitable for displaying visual information.

In an embodiment, the processor 110 may be a central processing unit (CPU), a graphics processing unit (GPU), a digital signal processor (DSP), an application-specific integrated circuit (ASIC), a field-programmable gate array (FPGA), or another computing unit suitable for executing the method of the present disclosure.

In an embodiment, the storage device 120 further includes other program code modules than the data receiving module 121, for example, a data filtering module, an event type identification module, an event decoding module, an analysis report generation module, a database update module, etc. The processor 110 may run these program code modules to implement the event log analysis method provided by the present disclosure. The processor 110 is configured to execute program instructions or program code modules stored in the storage device 120 to implement the event log analysis method of the present disclosure. The processor 110 may also perform multi-threaded processing to simultaneously analyze a plurality of event log files, so as to improve the processing efficiency of the system.

The storage device 120 may be a random access memory (RAM), a read-only memory (ROM), a flash memory, a hard disk drive (HDD), a solid state drive (SSD), or another device suitable for storing data and instructions.

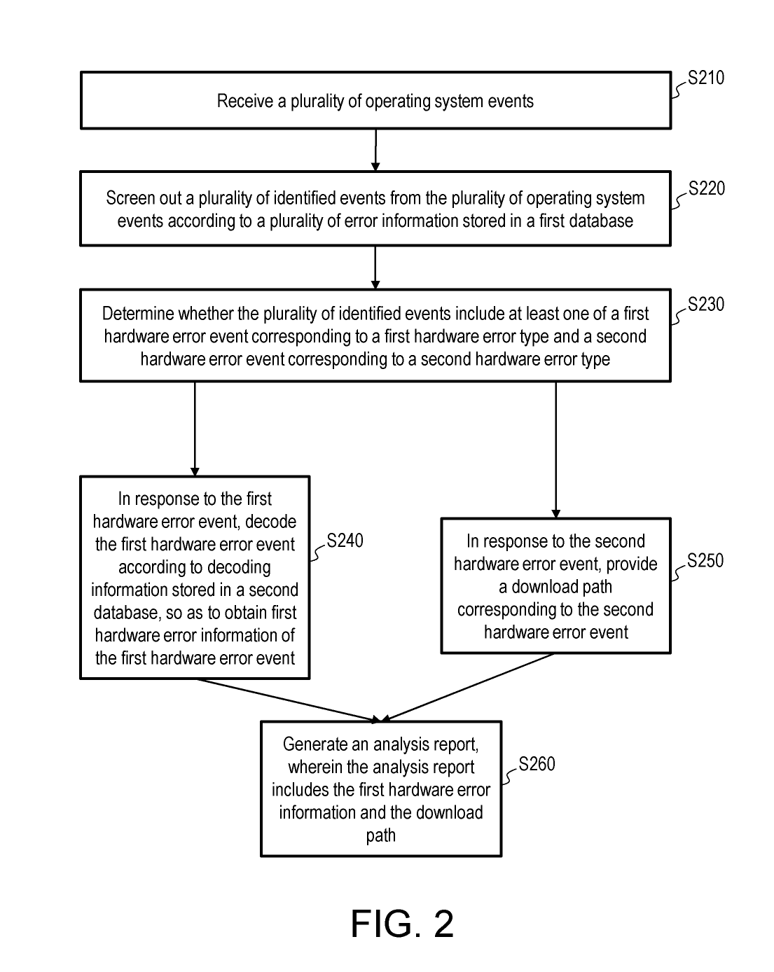

FIG. 2 is a flowchart of an event log analysis method according to an embodiment of the present disclosure.

Referring to FIG. 2, in an embodiment, FIG. 2 is a flowchart of an event log analysis method according to an embodiment of the present disclosure. The event log analysis method may be executed by the event log analysis system 10 as shown in FIG. 1 and is particularly implemented by the processor 110 of the event log analysis device 100 executing instructions stored in the storage device 120. The steps of the event log analysis method are described in detail below.

In step S210, the processor 110 receives a plurality of operating system events. The operating system events are contained in an event log file (.evtx), and a plurality of event log files may be further compressed into a compressed file. In this embodiment, a user may access a Web UI interface provided by the event log analysis device 100 through a Web browser of the user terminal 200 and upload a single event log file (.evtx) or a plurality of event log files compressed into a ZIP file. The data receiving module 121 receives these uploaded files and extracts the logs containing the operating system events. These operating system events may describe various types of system records, such as information on system startup, shutdown, software installation, hardware identification, error warnings, etc. Each operating system event usually includes data such as an event identifier (e.g., Event ID), an event source (e.g., an event source name displayed as "Kernel-WHEA" in the Windows Event Viewer), an event timestamp, an event message (error description, event level, etc.), related parameters, or specific error codes. According to actual application scenarios, the number of the operating system events may range from several hundred to tens of thousands, forming a large raw dataset.

In another embodiment, the event log analysis system 10 also provides an automated script tool for one-click retrieval of event log files from a user's system. This script tool is an executable batch file, capable of automatically performing the following operations on the user's operating system: identifying and locating the storage path of operating system event log files (such as .evtx files); copying key log files such as system logs, application logs, and security logs; performing preliminary compression processing on the retrieved log files; and directly uploading the compressed file to the event log analysis device 100 through a secure communication protocol. This automated script may simplify the process for the user to extract event logs, transforming tedious manual operations into simpler and easier operations, thereby improving the usability of the event log system.

In step S220, the processor 110 screens out a plurality of identified events from the plurality of operating system events based on a plurality of error information stored in the first database 122. The error information includes a plurality of known error codes. Information associated with the operating system events and the identified events includes: an event identifier, event source information, an event timestamp, event description information, and event parameter information.

The step of screening out a plurality of identified events from a plurality of operating system events based on a plurality of error information includes several steps: First, the processor 110 filters the plurality of operating system events based on a plurality of identifiers (which may be called Event IDs) of the plurality of operating system events to obtain a plurality of filtered operating system events (also called data preprocessing or first-stage filtering). Specifically, the processor 110 filters out events of Error and Warning levels according to the Event IDs and event sources while ignoring Information or Audit Success events because these events usually do not contain important clues to system problems.

Next, the processor 110 determines whether a plurality of error codes of the plurality of filtered operating system events matches the plurality of known error codes to generate a matching result. In this step, the processor 110 compares the error code and/or the identifier in each event with the known error codes in the first database 122 (which may be called an error information database). If an error code of an event matches an error code in the first database 122, this event is determined to be valid (screened out).

Finally, the processor 110 screens out the identified events based on the matching result and simultaneously deletes redundant information therein, such as events that repeatedly occur but have no substantial difference. Through this series of processes, the original operating system events, which may be as many as tens of thousands, can be effectively reduced to about one thousand valid errors or warning events, reducing the complexity of subsequent analysis and improving the efficiency of problem diagnosis.

In another embodiment, the processor 110 not only screens out a plurality of identified events, but also further classifies these events in detail according to their nature to facilitate subsequent analysis and problem diagnosis. Specifically, the identified event types include three major categories: a hardware problem type, a software problem type, and a firmware problem type. In another embodiment, the identified event types further include event records of a system crash caused by hardware, software, or firmware problems of the operating system, such as Blue Screen of Death (BSOD) records.

The hardware problem type further includes a first hardware error type (UEFI WHEA), a second hardware error type (Intel Crash log WHEA), and other hardware error types. The other hardware error types may include storage device errors, memory errors, graphics card errors, etc. These hardware errors usually directly reflect faults or abnormalities of physical components of the system and need to be handled with priority.

For example, the software problem type includes driver error events, system program error events, and memory allocation error events. The firmware problem type includes abnormal shutdown events and boot failure events. An abnormal shutdown event may be an abnormal system shutdown caused by incidents such as a sudden power interruption, a system crash, or the activation of a hardware protection mechanism. The aforementioned software problem types and firmware problem types are not limited to these.

Through this multi-level classification architecture, the processor 110 can perform more precise classification and diagnosis of system problems and may also set corresponding different display formats to improve readability, so as to facilitate the analysis and processing of system fault problems.

In step S230, the processor 110 determines whether the plurality of identified events includes at least one of a first hardware error event corresponding to either a first hardware error type or a second hardware error event corresponding to a second hardware error type. In this embodiment, the first hardware error type is UEFI WHEA, and the second hardware error type is Intel Crash log WHEA. In an embodiment, the processor 110 may further perform determination or confirmation according to specific features of the events, for example, the type thereof may be determined according to a data length of an event: a data length of an event of the UEFI WHEA type is usually greater than 256 bytes but less than 1024 bytes while a data length of an event of the Intel Crash log WHEA type is usually greater than 1024 bytes. The event logs of these two hardware error types may also be referred to as WHEA logs.

In step S240, in response to the first hardware error event, the processor 110 decodes the first hardware error event according to the decoding information stored in the second database 123 to obtain the first hardware error information of the first hardware error event. The second database 123 includes a UEFI decoding database, which contains basic information of hardware errors, such as error codes and correspondence relationships between the errors and the components where the errors occurred. In an embodiment, a WHEA log usually carries a specific event ID, and the processor 110 may utilize the UEFI decoding database to decode the first hardware error information, so that a user would understand the specific situation of the hardware error.

Specifically, a WHEA log is usually represented in binary code and cannot be intuitively understood by a user. The processor 110 finds out the specific code of an error through an error fragment in the WHEA log and uses an error model to search for a match in the UEFI decoding database. Through this comparison, the processor 110 can convert the original binary code into the first hardware error information with meaningful descriptions, such as information on the hardware component where the error occurred (e.g., memory, CPU, SSD, etc.), the error type, and the error severity. This decoded information, generated through a specific, rule-based technical process that is impossible for a human to perform efficiently or accurately on raw binary data, can help a user to quickly locate the hardware fault, effectively shortening the time for problem diagnosis and resolution.

The aforementioned decoding process makes the originally uninterpretable WHEA log intuitive and easy to understand, so as to improve the operability of hardware problem diagnosis.

In step S250, in response to the second hardware error event, the processor 110 provides a download path corresponding to the second hardware error event. Since the decoding of the second hardware error type (Intel Crash log WHEA) requires a proprietary tool from a chip supplier (e.g., Intel), the processor 110 does not directly decode this type of event, but instead provides a download path, allowing a user to download the Intel Crash log and upload it to the third-party software 124 (e.g., Intel System Debugger) provided by the chip supplier for further analysis. The processor 110 will provide a clear download link in the analysis report and guide the user how to upload the downloaded file to the third-party software 124 for analysis. Although this method requires additional operation steps from the user, it ensures that the Intel Crash log can be correctly parsed, so as to obtain more detailed hardware error information. In practical applications, the Intel Crash log usually indicates that a serious error related to an Intel processor or related hardware components has occurred in the system, and parsing the content of these logs can effectively locate the substantial hardware problem. In addition, in this analysis, potential hardware problems and experimental suggestions (such as checking the status of hardware such as the CPU, SSD, or motherboard) may also be proposed by further analyzing the Intel Crash log WHEA.

In step S260, the processor 110 generates an analysis report, and the analysis report includes the first hardware error information and the download path. The processor 110 includes the first hardware error information with meaningful descriptions and the download link for the Intel Crash log WHEA in the analysis report for a user to perform subsequent analysis.

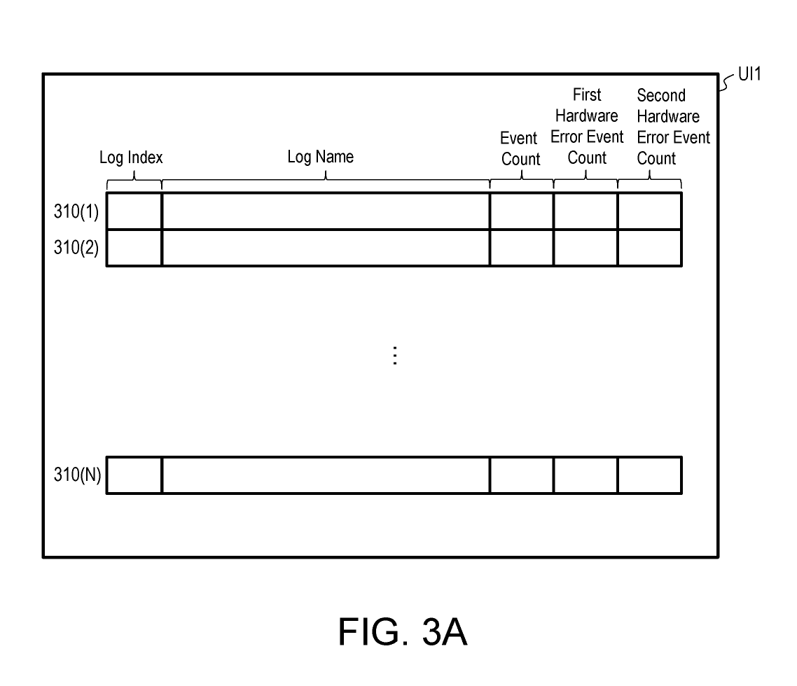

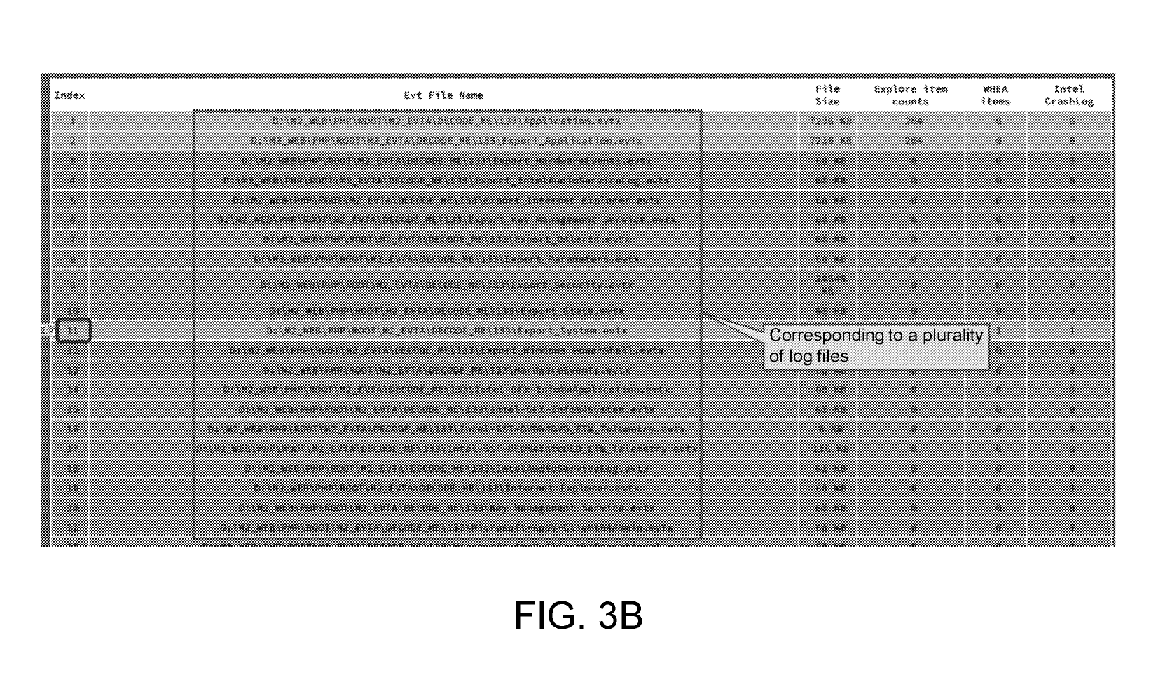

FIG. 3A is a schematic diagram of a file overview interface of an analysis report according to an embodiment of the present disclosure.

Referring to FIG. 3A, in an embodiment, FIG. 3A is a schematic diagram of a file overview interface of an analysis report according to an embodiment of the present disclosure. As shown in FIG. 3A, the file overview interface UI1 is one of the interfaces of the analysis report provided by the event log analysis system 10 for displaying key information of log files containing a plurality of operating system events.

In this embodiment, the file overview interface UI1 includes a tabular view, wherein each row (310(1), 310(2)...310(N)) represents a log file of an operating system event. Each row is divided into a plurality of columns to display key information of the log file including a log index, a log name, an event count, a first hardware error event count, and a second hardware error event count. In an embodiment, each row may also include a column corresponding to a file size.

The log index column of the file overview interface UI1 displays an identification number of each log file, which helps a user to quickly refer to a specific file. The log name column displays a file name of the operating system event log. The event count column displays the total number of identified events in each log file, providing a preliminary indicator of the complexity of the file content. The first hardware error event count column displays the number of UEFIWHEA hardware errors in each log file. The second hardware error event count column displays the number of Intel Crash log WHEA hardware errors in each log file. This design enables a user to quickly identify log files containing specific types of hardware errors, effectively promoting the efficiency of problem diagnosis.

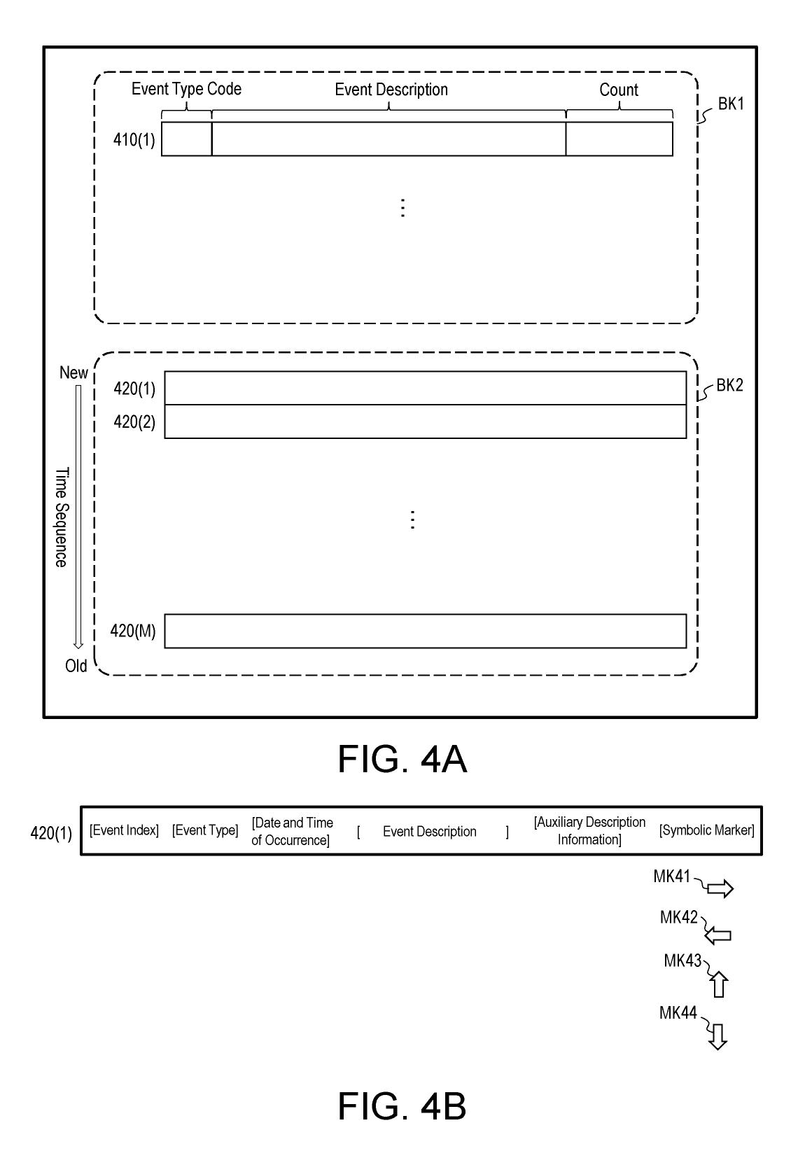

The processor 110 generates/updates this file overview interface after an event log file is uploaded from the user terminal 200 and updates the information in each column in real time after the analysis is completed. A user may click on a specific row to view a detailed analysis report of the log file (e.g., entering a specific event list interface, as shown in FIG. 4A), so as to obtain more in-depth event information and problem diagnosis results. A more specific implementation of the file overview interface may also refer to FIG. 3B.

FIG. 4A is a schematic diagram of an event list interface of an analysis report according to an embodiment of the present disclosure.

Referring to FIG. 4A, in an embodiment, the analysis report interface further includes an event list interface UI2 for displaying relevant information of a specific operating system event log when a user selects the specific operating system event log in the file overview interface. The event list interface UI2 includes two main areas: an event information area BK2 with a plurality of rows for displaying a plurality of events in the specific operating system event log in chronological order and a summary statistics area BK1 for displaying statistical information of a plurality of identified events in the specific operating system event log.

The summary statistics area BK1 is presented as the upper half of the event list interface UI2, displaying statistical data of various types of events in a tabular form. As shown in FIG. 4A, the summary statistics area BK1 includes a plurality of rows of statistical data (such as 410(1), etc.), and each row includes three columns: an event type code, an event description, and a count. The event type code column displays a known error code corresponding to each identified event type; the event description column details an error description corresponding to each known error code; and the count column counts the number of occurrences of each known error code in this event log. This summary statistics design provides a user with a quick preview of the problem distribution in the selected event log, which is helpful for preliminary diagnosis of the system condition.

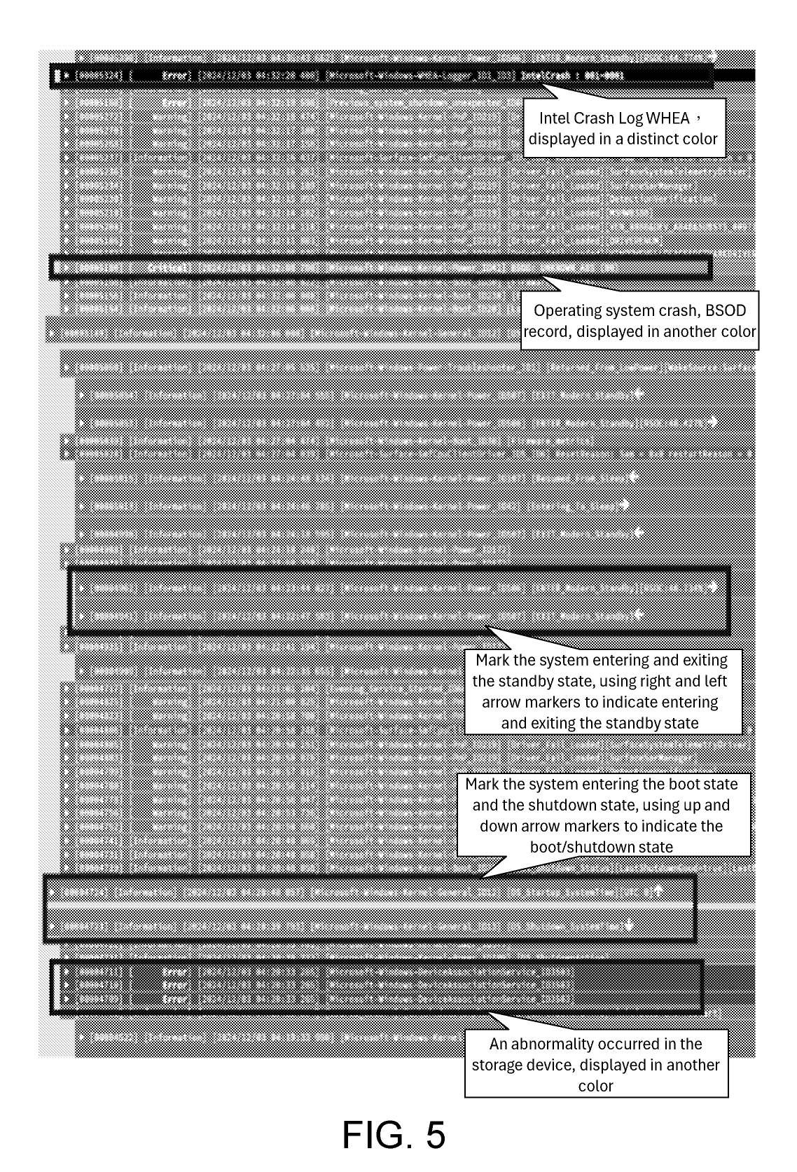

The event information area BK2 is located in the lower half of the event list interface UI2, displaying each identified event in chronological order. As shown in FIG. 4A, each row (420(1), 420(2)...420(M)) in the event information area BK2 represents a specific identified event, and those rows are arranged from newest to oldest according to the time sequence of event occurrence (e.g., a plurality of timestamps of the identified events). The events displayed in this area may adopt different background colors and symbolic markers according to the event types. More specifically, reference may be made to the actual example of the event information area shown in FIG. 5.

Referring to FIG. 4B, in an embodiment, FIG. 4B is a schematic diagram of a row in the event information area of FIG. 4A. As shown in FIG. 4B, the row 420(1) includes an event index, an event type, a date and time of occurrence, an event description, auxiliary description information, and a marker.

The marker part in the row 420(1) may display a plurality of symbolic markers to indicate changes in the system power state. These symbolic markers include: a right arrow marker MK41 for indicating that the system enters a standby state; a left arrow marker MK42 for indicating that the system exits the standby state; an up arrow marker MK43 for indicating that the system enters a boot state; and a down arrow marker MK44 for indicating that the system enters a shutdown state. These symbolic markers provide a user with intuitive visual indications to enable the user to quickly identify the change process of the system power state.

The processor 110 automatically sets an appropriate symbolic marker according to the event type and places it in the marker part of the row 420(1). This design ensures the integrity and readability of the event information and at the same time reduces the cognitive burden required for a user to interpret the changes in the system state, thereby improving the efficiency of system diagnosis.

The processor 110 generates this event list interface UI2 according to a user's selection in the file overview interface UI1, and the user may view more detailed information of an event by clicking on a specific event row. This interface design enables system administrators to both grasp the overall statistical information of the event log and view the time-series relationship of specific events, thereby improving the efficiency of system problem diagnosis.

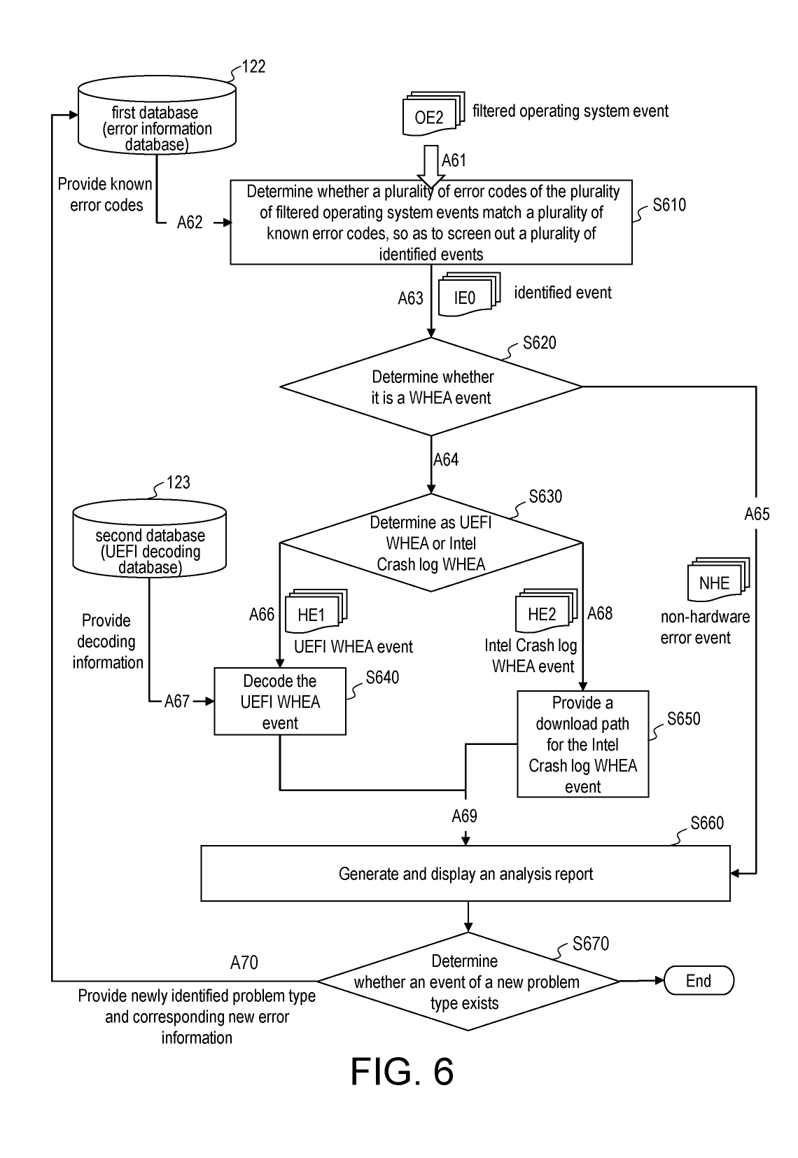

FIG. 6 is a flowchart of a log analysis method according to another embodiment of the present disclosure. As shown in FIG. 6, this flow starts from step S610, in which the processor 110 determines whether a plurality of error codes of filtered operating system events OE2 matches a plurality of known error codes, so as to screen out a plurality of identified events. As shown by arrow A61, the processor 110 receives the filtered operating system events OE2. Meanwhile, as shown by arrow A62, the processor 110 obtains the known error codes from the first database 122 (error information database). In this step, the processor 110 performs a detailed comparison operation, matching the error code in each of the filtered operating system events OE2 with the known error codes in the first database 122 to identify meaningful system events.

After the comparison is completed, as shown by arrow A63, the processor 110 generates identified events IE0. In step S620, the processor 110 further determines whether these identified events IE0 are WHEA events. This determination is based on specific features of the events, such as the event source (e.g., "Kernel-WHEA") and a specific event identifier. As shown by arrow A65, if the determination result is no, the processor 110 classifies the event as a non-hardware error event NHE and directly proceeds to step S660 to generate an analysis report. That is to say, even if no WHEA event exists in the identified events IE0, the processor 110 will still analyze the identified events IE0 to generate the analysis report.

If the determination result of step S620 is yes, then as shown by arrow A64, the flow proceeds to step S630. In step S630, the processor 110 further determines the specific type of the WHEA event and determine whether it is a UEFI WHEA or an Intel Crash log WHEA.

For example, the processor 110 parses a source identification field in an event record. If a "Kernel-WHEA" identifier is identified and is accompanied by a specific range of event identifiers (such as EVENT_ID: 17-20), it is preliminarily determined as a UEFI WHEA event HE1; if an "Intel-Platform-WHEA" or other Intel-proprietary identifier is identified, it is preliminarily determined as an Intel Crash log WHEA event HE2.

As shown by arrow A66, if the processor 110 determines the event to be the UEFI WHEA event HE1, the flow proceeds to step S640 to decode the UEFI WHEA event. As shown by arrow A67, the processor 110 obtains the decoding information from the second database 123 (UEFI decoding database). In step S640, the processor 110 decodes the UEFI WHEA event HE1 according to the decoding information and convert the original binary data into a human-readable form. Specifically, the processor 110 utilize an error model to search the UEFI decoding database for a match with an error fragment in the WHEA Log, so as to determine the specific code of each error and its corresponding hardware component.

As shown by arrow A68, if the processor 110 determines the event to be the Intel Crash log WHEA event HE2, the flow proceeds to step S650 to provide a download path for the Intel Crash log WHEA event. Since the decoding of the Intel Crash log WHEA requires a proprietary tool from Intel, the processor 110 does not directly decode this type of event in this step, but instead provides a download path, allowing a user to download the Intel Crash log and upload it to the Intel System Debugger provided by the system for further analysis.

Finally, as shown by arrow A69, the UEFI WHEA decoding result from step S640 and the Intel Crash log WHEA download path from step S650 are included in an analysis report. Meanwhile, as shown by arrow A65, the non-hardware error events NHE are also directed to step S660. That is to say, after the decoded UEFI WHEA decoding result, the Intel Crash log WHEA download path and the non-hardware error events are obtained, the processor 110 generates a visualized analysis report based on this information in step S660 through an analysis report interface. The analysis report integrates the analysis results of all types of events, including the decoded UEFI WHEA error information, the download path of the Intel Crash log WHEA (or the decoded information of the Intel Crash log WHEA), and relevant information of other non-hardware error events (for example, after clicking an event feature column of each event, the corresponding information can be expanded to be displayed to a user).

In another embodiment, as shown in FIG. 6, after generating the analysis report, the processor 110 further determines in step S670 whether an event of a new problem type exists.

In another embodiment, the processor 110 first identifies other events from the identified events IE0 that do not belong to either the first hardware error type (UEFI WHEA) or the second hardware error type (Intel Crash log WHEA). These other events may include new problem types such as conventional software errors, firmware problems, or other non-WHEA type hardware errors. The diagnostic value of a new problem type may be confirmed and labeled by a user performing the following steps: First, analyzing how much the new problem type event may impact the system, including whether it causes a change in system state (such as reboot, performance degradation) or its correlation with other known error events. Second, evaluating the frequency of occurrence of the new problem type event in a plurality of event logs, where frequently occurring events have a higher classification value.

After the new problem type is labeled, as shown by arrow A70, the processor 110 provides the newly identified problem type and the corresponding new error information to the first database 122, so as to update the first database 122. When it is determined in step S670 that no new problem type exists, the flow ends directly. After the new error information corresponding to the new problem type is successfully added to the first database 122, the system records this update operation and applies the updated database content in the next event log analysis, so as to ensure that the diagnostic capability of the system is continuously enhanced. This database iterative update mechanism enables the system to learn and evolve from a large number of actual cases and gradually enhances the error identification capability with the user's use. This feedback loop represents a technical improvement to the functioning of the computer system, allowing it to become more effective over time without manual reprogramming.

It should be noted that the detailed description of the appearance of the analysis report has been described above with reference to FIGS. 3A-4B and will not be repeated here.

In summary, the event log analysis system of the present disclosure provides an efficient technical solution for processing operating system event logs by integrating data screening, hardware error decoding, and dynamic database updates. The technical solution overcomes the technical barriers faced by conventional tools and manual analysis, particularly in handling non-standard, human-unreadable binary log formats. The system utilizes the processor to automatically identify key error events from a large number of event logs according to the error information of the first database and achieves precise analysis of hardware errors such as UEFI WHEA and Intel Crash Log through the decoding function of the second database and the collaborative processing of third-party software. At the same time, the system can quickly classify different types of hardware errors based on a multiple-judgment mechanism of data length and event features. In addition, through the database update module, the system can continuously identify and record newly identified event error types, enhancing its adaptability to unknown problems and thereby improving its own operational logic and accuracy over time.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An Event Log Analysis System, comprising:
a data receiving module, for receiving a plurality of operating system events;
a first database, for storing a plurality of error information;
a second database, for storing decoding information; and
a processor, coupled to the data receiving module, the first database, and the second database, wherein the processor is configured to:
screen out a plurality of identified events from the plurality of operating system events based on the plurality of error information;
determine whether the plurality of identified events include at least one of a first hardware error event corresponding to a first hardware error type and a second hardware error event corresponding to a second hardware error type;
in response to the first hardware error event, decode the first hardware error event according to the decoding information to obtain first hardware error information of the first hardware error event;
in response to the second hardware error event, provide a download path corresponding to the second hardware error event; and
generate an analysis report, wherein the analysis report includes the first hardware error information and the download path.

2. The Event Log Analysis System of claim 1, wherein the first hardware error type is UEFI Windows Hardware Error Architecture (WHEA), and the second hardware error type is Intel Crash log WHEA.

3. The Event Log Analysis System of claim 1, wherein the plurality of error information include a plurality of known error codes, wherein screening out the plurality of identified events from the plurality of operating system events based on the plurality of error information comprises:
filtering the plurality of operating system events based on a plurality of identifiers of the plurality of operating system events to obtain a plurality of filtered operating system events;
determining whether a plurality of error codes of the plurality of filtered operating system events match a plurality of known error codes to generate a matching result; and
screening out the plurality of identified events based on the matching result.

4. The Event Log Analysis System of claim 1, wherein the processor is further configured to group and label the plurality of identified events and set display colors of the plurality of identified events in the analysis report according to a plurality of problem types, wherein the plurality of problem types include at least one of the following:
a hardware problem type, including the first hardware error type and the second hardware error type;
a software problem type; and
a firmware problem type.

5. The Event Log Analysis System of claim 1, wherein the processor is further configured to:
arrange the plurality of identified events in a chronological order in the analysis report according to a plurality of timestamps of the plurality of identified events.

6. The Event Log Analysis System of claim 1, wherein the processor is further configured to:
determine the first hardware error event and the second hardware error event according to a first preset length and a second preset length,
wherein a data length of the first hardware error event is greater than the first preset length and less than the second preset length, and a data length of the second hardware error event is greater than the second preset length.

7. The Event Log Analysis System of claim 1, wherein the processor is further configured to:
when the plurality of identified events comprises other events not belonging to either the first hardware error type or the second hardware error type, determine whether the other events have new error information that is not present in the first database; and
in response to the new error information, add the new error information to the first database.

8. An Event Log Analysis Method, comprising:
receiving a plurality of operating system events;
screening out a plurality of identified events from the plurality of operating system events based on a plurality of error information stored in a first database;
determining whether the plurality of identified events include at least one of a first hardware error event corresponding to a first hardware error type and a second hardware error event corresponding to a second hardware error type;
in response to the first hardware error event, decoding the first hardware error event according to decoding information stored in a second database to obtain first hardware error information of the first hardware error event;
in response to the second hardware error event, providing a download path corresponding to the second hardware error event; and
generating an analysis report, wherein the analysis report includes the first hardware error information and the download path.

9. The Event Log Analysis Method of claim 8, wherein the first hardware error type is UEFI Windows Hardware Error Architecture (WHEA), and the second hardware error type is Intel Crash log WHEA.

10. The Event Log Analysis Method of claim 8, wherein the plurality of error information includes a plurality of known error codes, wherein screening out the plurality of identified events from the plurality of operating system events based on the plurality of error information comprises:
filtering the plurality of operating system events based on a plurality of identifiers of the plurality of operating system events to obtain a plurality of filtered operating system events;
determining whether a plurality of error codes of the plurality of filtered operating system events match the plurality of known error codes to generate a matching result; and
screening out the plurality of identified events based on the matching result.

11. The Event Log Analysis Method of claim 8, further comprising grouping and labeling the plurality of identified events and setting display colors of the plurality of identified events in the analysis report according to a plurality of problem types, wherein the plurality of problem types includes at least one of the following:
a hardware problem type, including the first hardware error type and the second hardware error type;
a software problem type; and
a firmware problem type.

12. The Event Log Analysis Method of claim 8, further comprising:
arranging the plurality of identified events in a chronological order in the analysis report according to a plurality of timestamps of the plurality of identified events.

13. The Event Log Analysis Method of claim 8, further comprising:
determining the first hardware error event and the second hardware error event according to a first preset length and a second preset length,
wherein a data length of the first hardware error event is greater than the first preset length and less than the second preset length, and a data length of the second hardware error event is greater than the second preset length.

14. The Event Log Analysis Method of claim 8, further comprising:
when the plurality of identified events comprises other events not belonging to either the first hardware error type or the second hardware error type, determining whether the other events have new error information that is not present in the first database; and
in response to the new error information, adding the new error information to the first database.
